(19) United States
(12) Patent Application Publication
(10) Pub. No.: US 2025/0074767 A1
(43) Pub. Date: Mar. 6, 2025

(54) GREEN HYDROGEN PRODUCTION SYSTEM, GREEN POWER PRODUCTION SYSTEM, GREEN HYDROGEN AND GREEN POWER PRODUCTION SYSTEM, AND METHOD OF IMPLEMENTING THE SAME

(71) Applicant: CHI-SHENG WANG, IRVINE, CA (US)

(72) Inventor: CHI-SHENG WANG, IRVINE, CA (US)

(21) Appl. No.: 18/504,377

(22) Filed: Nov. 8, 2023

(30) Foreign Application Priority Data
Aug. 30, 2023 (TW) 112132847

(51) Int. Cl. C01B 3/06; B01J 8/08; B01J 38/00; C01B 3/08

(52) U.S. Cl. CPC C01B 3/063; B01J 8/085; B01J 8/087; B01J 38/00; C01B 3/08; B01J 2208/00849

(57) ABSTRACT

A green hydrogen production system, a green power production system, a green hydrogen and green power production system, and methods of implementing the same are provided. Catalyst for hydrogen production is sent to a raw-material mixing unit, mixed with water, and then reacted in a first water splitting unit therein to generate hydrogen gas and oxidized catalyst for hydrogen production. The hydrogen gas is delivered to a hydrogen power generation unit to produce power while the oxidized catalyst for hydrogen production is sent to a photon-plasma decomposition unit for being reduced into the catalyst for hydrogen production and oxygen generated is sent to the hydrogen power generation unit to generate power. Thereby hydrogen, power, and raw materials used in the system are recycled during operation. Therefore, green hydrogen and green power with reasonable price obtained can replace fossil fuels to solve climate change and global warming issues.

### BACKGROUND OF THE INVENTION

### Field of the Invention

The present invention relates to green energy, especially to a green hydrogen production system, a green power production system, a green hydrogen and green power production system, and methods of implementing the same.

### Description of Related Art

Among a plurality of pollution sources which causes greenhouse effect, carbon dioxide is most effective. Carbon dioxide is released from the burning of fossil fuels. In order to reduce emissions of carbon dioxide, our dependency and use of fossil fuels should be limited. In Paris agreement, development of renewable energy and green hydrogen to replace fossil fuels has been proposed. However, most of methods of producing green hydrogen available now use water electrolysis to get green hydrogen and electricity used to split water comes from renewable energy such as solar energy and wind power. Thus the cost of green hydrogen from electrolysis is relatively high and difficult to compete with fossil fuels.

### SUMMARY OF THE INVENTION

Therefore, it is a primary object of the present invention to provide a green hydrogen production system, a green power production system, a green hydrogen and green power production system, and methods of the same which produce green hydrogen and green power with reasonable price to solve problems of climate change and global warming caused by fossil fuels effectively.

In order to achieve the above object, a green hydrogen production system, a green power production system, a green hydrogen and green power production system, and methods of the same according to the present invention are provided. Catalyst for hydrogen production is sent to a raw-material mixing unit and mixed with water. Then a mixture of the catalyst for hydrogen production and the water is reacted in a first water splitting unit to have water splitting reaction therein and generate hydrogen gas and oxidized catalyst for hydrogen production. The hydrogen gas is delivered to a hydrogen power generation unit to produce green power while the oxidized catalyst for hydrogen production is sent to a photon-plasma decomposition unit for being reactivated and reduced into the catalyst for hydrogen production and oxygen generated is sent to the hydrogen power generation unit to generate power. Thereby green hydrogen and green power used in the system are recycled during operation. Raw materials including the catalyst for hydrogen production and water can also be recycled in the system. Therefore, green hydrogen and green power with reasonable price obtained can replace fossil fuels and problems caused by fossil fuels including climate change and global warming can be solved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing structure of a green hydrogen production system according to the present invention;

FIG. 2 is a schematic drawing showing structure of a green power production system according to the present invention;

FIG. 3 is a schematic drawing showing structure of a green hydrogen and green power production system according to the present invention;

FIG. 4 is a schematic drawing showing a sectional view of a photon-plasma decomposition unit according to the present invention.

### DETAILED DESCRIPTION OF THE PREFERRED EMBODIMENT

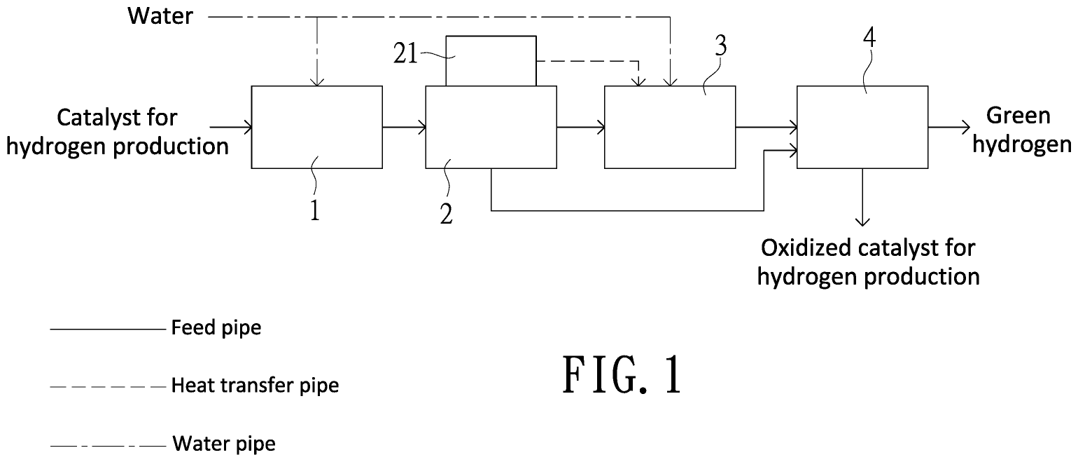

Refer to FIG. 1, a green hydrogen production system according to the present invention mainly includes a raw-material mixing unit 1 connected with a feed pipe which is externally connected with catalyst for hydrogen production, a first water splitting unit 2 connected with the raw-material mixing unit 1 by a feed pipe, a heat recovery unit 3 connected with the first water splitting unit 2 by a feed pipe, and a separation unit 4 connected with the heat recovery unit 3 and the first water splitting unit 2 by feed pipes correspondingly. The first water splitting unit 2 is provided with a first heat exchange module 21 which is connected with the heat recovery unit 3 by a heat transfer pipe. Both the raw-material mixing unit 1 and the heat recovery unit 3 are connected with a water pipe which is connected with an external water source.

When the present green hydrogen production system produces green hydrogen, the externally connected catalyst for hydrogen production is sent to the raw-material mixing unit 1 through the feed pipe. The catalyst for hydrogen production can be one of common metals (also called base metals), metal alloys, metal oxides, and their combinations. The preferred metal includes copper, iron, aluminum, tin, lead, zinc, sodium, calcium, lithium, potassium, nickel, magnesium, gallium, cadmium, silicon, titanium, etc. The preferred metal oxide includes copper peroxide [CuO₂], ferric oxide [Fe₂O₃], ferrous ferric oxide [Fe₃O₄], aluminum oxide [Al2O3], stannic oxide [SnO2], lead dioxide [PbO₂], zinc oxide [ZnO], sodium oxide [Na₂O], calcium oxide [CaO], lithium oxide [Li₂O], potassium oxide [K₂O], nickel oxide [Ni₂O], magnesium oxide [Mgo], gallium oxide [Ga₂O3], cadmium oxide [CdO], silicon dioxide [SiO₂], titanium oxide [TiO2], etc. The external water source supplies pure water which is sent to the raw-material mixing unit 1 by the water pipe. Thus the catalyst for hydrogen production and the water are mixed evenly in the raw-material mixing unit 1 and then a mixture of the catalyst for hydrogen production and the water is sent to the first water splitting unit 2 to perform water splitting reaction therein and generate hydrogen gas and oxidized catalyst for hydrogen production. A large amount of heat of enthalpy generated during production of the oxidized catalyst for hydrogen production and a small part of the catalyst for hydrogen production not completely reacted are released. Then the heat of enthalpy is absorbed by the first heat exchange module 21 of the first water splitting unit 2 and transferred to the heat recovery unit 3 by the heat transfer pipe. The catalyst for hydrogen production not completely reacted in the first water splitting unit 2 is sent to the heat recovery unit 3 by the feed pipe and the water from the external water source is also delivered to the heat recovery unit 3 by the water pipe. Now the heat of enthalpy and the water gathered allow the catalyst for hydrogen production not completely reacted to be excited and reacted completely to generate hydrogen gas and oxidized catalyst for hydrogen production. Next the hydrogen gas and the oxidized catalyst for hydrogen production generated by the first water splitting unit 2 and the heat recovery unit 3 are sent to the separation unit 4 through the feed pipes for separating the hydrogen gas (green hydrogen in gas form) and the oxidized catalyst for hydrogen production in solid form. The green hydrogen can be output from the system to the outside through the feed pipe for various applications. The oxidized catalyst for hydrogen production can also be sent to the outside to be used.

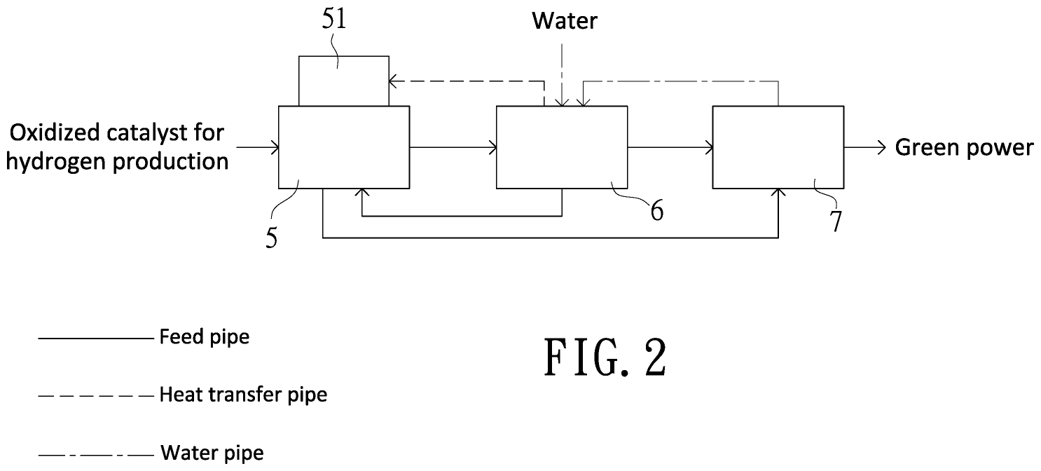

As shown in FIG. 2, a green power production system according to the present invention mainly includes a photon-plasma decomposition unit 5 which is connected with a feed pipe externally connected to oxidized catalyst for hydrogen production, a second water splitting unit 6 connected with the photon-plasma decomposition unit 5 by a feed pipe, and a hydrogen power generation unit 7. The photon-plasma decomposition unit 5 is provided with a second heat exchange module 51 which is connected with the second water splitting unit 6 by a heat transfer pipe while the second water splitting unit 6 is connected with a water pipe which is connected with an external water source. Both the photon-plasma decomposition unit 5 and the second water splitting unit 6 are connected to the hydrogen power generation unit 7 by a feed pipe. The hydrogen power generation unit 7 is further connected with the second water splitting unit 6 by a water pipe. The hydrogen power generation unit 7 is a hydrogen power generation device including hydrogen fuel cell (such as proton-exchange membrane fuel cell (PEMFC), and solid oxide fuel cell (SOFC)) hydrogen internal combustion engine, hydrogen gas turbine, etc.

While generating green power by the green power production system of the present invention, the oxidized catalyst for hydrogen production produced by the present green hydrogen production system is used. The oxidized catalyst for hydrogen production is delivered into the photon-plasma decomposition unit 5 by the feed pipe for reactivation and reduction to produce catalyst for hydrogen production. Then the catalyst for hydrogen production produced is sent to the second water splitting unit 6 through the feed pipe to be reacted with water from the external water source to the second water splitting unit 6 through the water pipe. Thereby hydrogen gas and oxidized catalyst for hydrogen production are generated after water splitting reaction and a large amount of heat of enthalpy generated during production of the oxidized catalyst for hydrogen production is released. The heat of enthalpy is delivered to the second heat exchange module 51 of the photon-plasma decomposition unit 5 by the heat transfer pipe to be absorbed and used as a part of reduction heat for saving electricity and enhancing reductive degradation efficiency of the oxidized catalyst for hydrogen production. Moreover, the oxidized catalyst for hydrogen production generated in the second water splitting unit 6 is sent back to the photon-plasma decomposition unit 5 through the feed pipe to be recycled between the photon-plasma decomposition unit 5 and the second water splitting unit 6. While the oxidized catalyst for hydrogen production is reduced to the catalyst for hydrogen production in the photon-plasma decomposition unit 5, oxygen gas is also generated at the same time. The oxygen gas is sent to the hydrogen power generation unit 7 by the feed pipe while the hydrogen gas generated in the second water splitting unit 6 is also delivered to the hydrogen power generation unit 7 by the feed pipe to work together with the oxygen gas sent to the hydrogen power generation unit 7 for production of green power and water. The water generated by the hydrogen power generation unit 7 is sent to the second water splitting unit 6 by the water pipe to fill water required for water splitting reaction in the second water splitting unit 6. The green power generated can provide electricity required for system operation or output to the outside of the system for various applications. The oxidized catalyst for hydrogen production is a common metal, metal alloy, metal oxide, and a combination thereof. The preferred metal includes copper, iron, aluminum, tin, lead, zinc, sodium, calcium, lithium, potassium, nickel, magnesium, gallium, cadmium, silicon, titanium, etc. The preferred metal oxide includes copper peroxide [CuO₂], ferric oxide [Fe₂O₃], ferrous ferric oxide [Fe₃O₄], aluminum oxide [Al2O3], stannic oxide [SnO2], lead dioxide [PbO₂], zinc oxide [ZnO], sodium oxide [Na₂O], calcium oxide [CaO], lithium oxide [Li₂O], potassium oxide [K₂O], nickel oxide [Ni₂O], magnesium oxide [Mgo], gallium oxide [Ga2O3], cadmium oxide [CdO], silicon dioxide [SiO₂], titanium oxide [TiO2], etc.

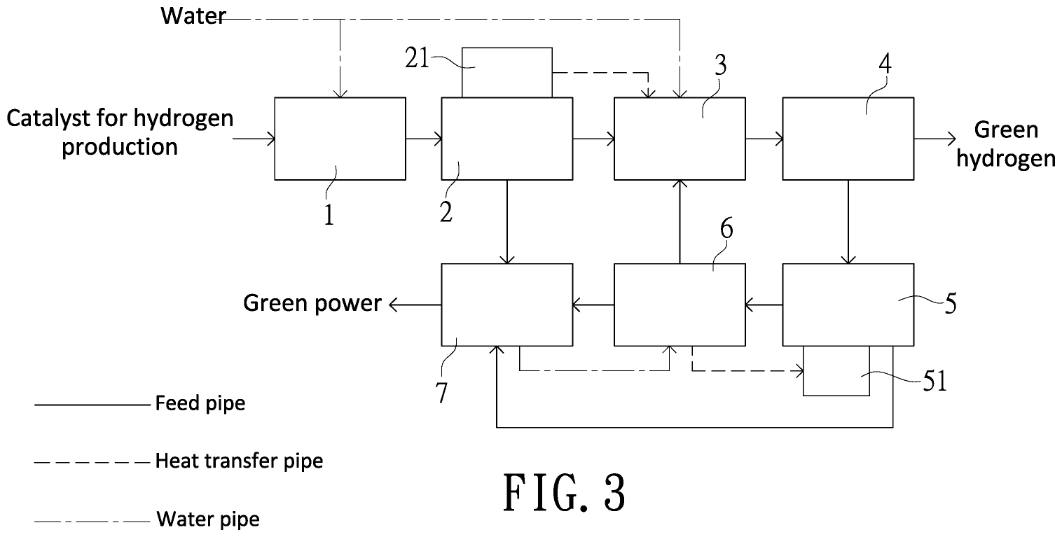

As shown in FIG. 3, a green hydrogen and green power production system according to the present invention is formed by a green hydrogen production system integrated with a green power production system and composed of a raw material mixing unit 1 connected with a feed pipe which is externally connected to catalyst for hydrogen production, a first water splitting unit 2 connected with the raw material mixing unit 1 by a feed pipe, a heat recovery unit 3 connected with the first water splitting unit 2 by a feed pipe, a separation unit 4 connected with the heat recovery unit 3 by a feed pipe, a photon-plasma decomposition unit 5 connected with the separation unit 4 by a feed pipe, a second water splitting unit 6 connected with each of the photon-plasma decomposition unit 5 and the heat recovery unit 3 by a corresponding feed pipe, and a hydrogen power generation unit 7 connected with each of the first water splitting unit 2, the photon-plasma decomposition unit 5, and the second water splitting unit 6 by a feed pipe. The first water splitting unit 2 is provided with a first heat exchange module 21 which is connected with the heat recovery unit 3 by a heat transfer pipe. The photon-plasma decomposition unit 5 is provided with a second heat exchange module 51 which is connected with the second water splitting unit 6 by a heat transfer pipe. The hydrogen power generation unit 7 is further connected with the second water splitting unit 6 by a water pipe while both the raw material mixing unit 1 and heat recovery unit 3 are connected to a water pipe which is connected with an external water source.

While in use, the externally connected catalyst for hydrogen production is delivered to the raw material mixing unit 1 by the feed pipe and water from the external water source is also sent to the raw material mixing unit 1 by the water pipe so that the catalyst for hydrogen production and the water are mixed evenly in the raw material mixing unit 1. Then a mixture of the catalyst for hydrogen production and the water is delivered to the first water splitting unit 2 to carry out water splitting reaction therein for producing hydrogen gas and oxidized catalyst for hydrogen production and releasing both a larger amount of heat of enthalpy generated during production of the oxidized catalyst for hydrogen production and a small part of the catalyst for hydrogen production not completely reacted. The heat of enthalpy is absorbed by the first heat exchange module 21 of the first water splitting unit 2 and delivered to the heat recovery unit 3 by the heat transfer pipe. As to the catalyst for hydrogen production not completely reacted in the first water splitting unit 2, it is delivered to the heat recovery unit 3 by the feed pipe and water from the external water source is also sent to the heat recovery unit 3 by the water pipe. Now the heat of enthalpy and the water gathered allow the catalyst for hydrogen production not completely reacted to be excited and reacted completely to generate hydrogen gas and oxidized catalyst for hydrogen production. Then the hydrogen gas and the oxidized catalyst for hydrogen production generated by the first water splitting unit 2 and the heat recovery unit 3 are sent to the separation unit 4 by the feed pipes for separating the hydrogen gas (green hydrogen in gas form) and the oxidized catalyst for hydrogen production in solid form. The green hydrogen can be used by the system or output from the system to the outside for various applications. The oxidized catalyst for hydrogen production is delivered into the photon-plasma decomposition unit 5 by the feed pipe for reactivation and catalyst for hydrogen production is obtained after reduction. Then the catalyst for hydrogen production produced is sent to the second water splitting unit 6 by the feed pipe for performing water splitting reaction. Thus hydrogen gas and oxidized catalyst for hydrogen production are generated and a large amount of heat of enthalpy generated during production of the oxidized catalyst for hydrogen production is released. The heat of enthalpy is delivered to the second heat exchange module 51 of the photon-plasma decomposition unit 5 by the heat transfer pipe to be absorbed and used as a part of reduction heat for saving electricity and enhancing reductive degradation efficiency of the oxidized catalyst for hydrogen production. As to the oxidized catalyst for hydrogen production generated in the second water splitting unit 6, it is sent to the heat recovery unit 3 by the feed pipe to be recycled among the heat recovery unit 3, the separation unit 4, the photon-plasma decomposition unit 5, and the second water splitting unit 6 in turn. While the oxidized catalyst for hydrogen production is reduced into the catalyst for hydrogen production in the photon-plasma decomposition unit 5, oxygen gas is also generated at the same time and then sent to the hydrogen power generation unit 7 by the feed pipe. Moreover, the hydrogen gas generated by the first water splitting unit 2 and the second water splitting unit 6 is delivered to the hydrogen power generation unit 7 by the feed pipes to react with the oxygen gas sent to the hydrogen power generation unit 7 and produce green power and water. The water produced in the hydrogen power generation unit 7 is sent to the second water splitting unit 6 by the water pipe to fill water required for water splitting reaction in the second water splitting unit 6. The green power generated by the hydrogen power generation unit 7 can provide electricity required for system operation or output to the outside of the system for various applications.

The green hydrogen and green power used in the system are self-sufficient and recyclable during operation. The green hydrogen is produced without using water electrolysis and there is no need to use renewable power such as solar energy and wind power. Thereby cost for green hydrogen and green power is significantly saved. Moreover, raw materials used in the system include catalyst for hydrogen production, water, etc. The catalyst for hydrogen production can be reactivated and recycled in the system after use and water is also recycled during operation of the system to reduce the amount of water from outside required significantly. Therefore, green hydrogen and green power with reasonable price obtained can be used to replace fossil fuels for effectively solving climate change and global warming issues caused by fossil fuels. The production of green hydrogen and green power in the present invention is reversible and interchangeable. The green hydrogen production and storage are performed at night when power is cheap while the green hydrogen is used to produce green power during peak period at daytime. By such elastic and diversified implementation, abundant income is generated and economic efficiency is further enhanced. In addition, the present system produces green hydrogen on-site and on-demand. Water is added to generate green hydrogen only when hydrogen gas is required. The catalyst for hydrogen production in solid form is used to produce green hydrogen so that problems such as unsafety and high cost of hydrogen storage and transportation can be solved effectively.

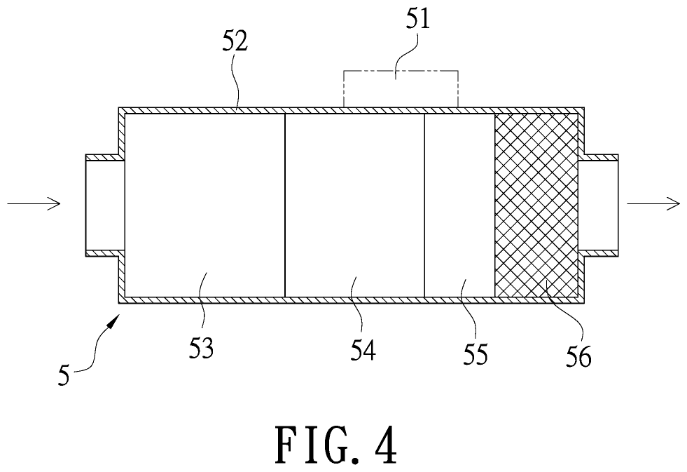

It should be noted that the photon-plasma decomposition unit 5, as shown in FIG. 4, the photon-plasma decomposition unit 5 according to the present invention includes a main body 52 and a second heat exchange module 51 arranged outside the main body 52. An artificial lightning module 53, a photon-plasma decomposition module 54, an energy retention, reformate, and conditioning module 55, and a separation and purification module 56 are mounted in the main body 52 in turn. After entering the photon-plasma decomposition unit 5, the oxidized catalyst for hydrogen production is treated by artificial lightning, photon plasma decomposition, energy retention, reformate, and conditioning, and separation and purification in turn to be reduced into the catalyst for hydrogen production. Thereby the oxidized catalyst for hydrogen production is continuously reactivated and reduced into new catalyst for hydrogen production by the photon-plasma decomposition unit 5 for being used again.

In summary, the present invention has the following advantages.

1. The green hydrogen and green power used in the system are self-sufficient and recyclable during operation. The green hydrogen is produced without using water electrolysis and renewable power such as solar and wind power is required. Thereby cost for green hydrogen and green power is significantly saved.

2. Raw materials used in the system include catalyst for hydrogen production, water, etc. The catalyst for hydrogen production can be reactivated and recycled in the system and water is also recycled during operation of the system to reduce the amount of water from outside significantly. Thus the cost is further saved.

3. The raw materials used in the system include catalyst for hydrogen production and water can be recycled during operation of the system so that green hydrogen and green power with low price are obtained. The production cost of the present method is lower than other green hydrogen production methods available now and is quite competitive in the market.

4. The present system produces green hydrogen on-site and on-demand. Water is added to generate green hydrogen only when hydrogen gas is required. The catalyst for hydrogen production in solid form is used to produce green hydrogen so that problems such as unsafety and high cost of hydrogen storage and transportation can be solved effectively.

5. The present system can obtain green hydrogen and green power with low price which can replace fossil fuels effectively to solve climate change and global warming problems. At the same time, abundant income is generated and economic efficiency is further enhanced.

6. The green hydrogen and green power in the present system features on reversible and interchangeable abilities. The green hydrogen production and storage are performed when power is cheap while the green power is generated when electricity is expensive. By such flexible and diversified implementation, production of green hydrogen and green power is more cost-effective.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A green hydrogen production system comprising:
a raw-material mixing unit connected with a feed pipe which is externally connected with a catalyst for hydrogen production,
a first water splitting unit connected with the raw-material mixing unit by a feed pipe and provided with a first heat exchange module;
a heat recovery unit respectively connected with the first water splitting unit and the first heat exchange module by a feed pipe and a heat transfer pipe; and
a separation unit connected with each of the heat recovery unit and the first water splitting unit by a feed pipe; both the raw-material mixing unit and the heat recovery unit are further connected with a water pipe which is connected with an external water source.

2. A green power production system comprising:
a photon-plasma decomposition unit connected with a feed pipe, the feed pipe externally connected with oxidized catalyst for hydrogen production,
a second water splitting unit not only connected with a water pipe, the water pipe connected with an external water source, but also connected with the photon-plasma decomposition unit by a feed pipe, and
a hydrogen power generation unit connected with each of the photon-plasma decomposition unit and the second water splitting unit by a feed pipe correspondingly;
the photon-plasma decomposition unit provided with a second heat exchange module, the second heat exchange module connected with the second water splitting unit by a heat transfer pipe and the hydrogen power generation unit further connected with the second water splitting unit by a water pipe.

3. The green power production system as claimed in claim 2, wherein the hydrogen power generation unit is a hydrogen fuel cell, a hydrogen internal combustion engine, or a hydrogen gas turbine.

4. A green hydrogen and green power production system comprising:
a raw material mixing unit connected with a feed pipe which is externally connected with catalyst for hydrogen production,
a first water splitting unit connected with the raw material mixing unit by a feed pipe,
a heat recovery unit connected with the first water splitting unit by a feed pipe,
a separation unit connected with the heat recovery unit by a feed pipe,
a photon-plasma decomposition unit connected with the separation unit by a feed pipe,
a second water splitting unit not only connected with the photon-plasma decomposition unit by a feed pipe but also connected with the heat recovery unit by a feed pipe, and
a hydrogen power generation unit connected with each the first water splitting unit, the photon-plasma decomposition unit, and the second water splitting unit by respective pipes; the first water splitting unit is provided with a first heat exchange module which is connected with the heat recovery unit by a heat transfer pipe while the photon-plasma decomposition unit is provided with a second heat exchange module which is connected with the second water splitting unit by a heat transfer pipe; the hydrogen power generation unit is further connected with the second water splitting unit by a water pipe while both the raw material mixing unit and heat recovery unit are connected to a water pipe which is connected to an external water source.

5. The green hydrogen and green power production system as claimed in claim 4, wherein the hydrogen power generation unit is a hydrogen fuel cell, a hydrogen internal combustion engine, or a hydrogen gas turbine.

6. A method of implementing the green hydrogen production system as claimed in claim 1 comprising the steps of:
A. sending the externally connected catalyst for hydrogen production to the raw-material mixing unit through the feed pipe;
B. sending water from the external water source to the raw-material mixing unit through the water pipe so that the catalyst for hydrogen production and the water are mixed in the raw-material mixing unit;
C. delivering a mixture of the catalyst for hydrogen production and the water to the first water splitting unit through the feed pipe to perform water splitting reaction therein, produce hydrogen gas and oxidized catalyst for hydrogen production, and release a large amount of heat of enthalpy generated during production of the oxidized catalyst for hydrogen production and a small part of the catalyst for hydrogen production not completely reacted;
D. absorbing the heat of enthalpy by the first heat exchange module of the first water splitting unit and transferring the heat of enthalpy to the heat recovery unit by the heat transfer pipe; also delivering the catalyst for hydrogen production not completely reacted in the first water splitting unit to the heat recovery unit by the feed pipe;
E. sending water from the external water source to the heat recovery unit through the water pipe so that the heat of enthalpy and the water gathered allow the catalyst for hydrogen production not completely reacted to be excited and reacted completely to generate hydrogen gas and oxidized catalyst for hydrogen production; and
F. delivering the hydrogen gas and the oxidized catalyst for hydrogen production generated by the first water splitting unit and the heat recovery unit to the separation unit through the feed pipes for separating the hydrogen gas and the oxidized catalyst for hydrogen production in solid form.

7. The method as claimed in claim 6, wherein the catalyst for hydrogen production is selected from the group consisting of a common metal, metal alloy, metal oxide, and a combination thereof.

8. A method of implementing the green power production system as claimed in claim 2 comprising the steps of:
A. sending the externally connected oxidized catalyst for hydrogen production into the photon-plasma decomposition unit by the feed pipe for reactivation and reduction to obtain catalyst for hydrogen production;
B. delivering the catalyst for hydrogen production obtained to the second water splitting unit by the feed pipe for being reacted with water from the external water source to the second water splitting unit through the water pipe so that hydrogen gas and oxidized catalyst for hydrogen production are produced after water splitting reaction and a large amount of heat of enthalpy generated during production of the oxidized catalyst for hydrogen production is released;
C. delivering the heat of enthalpy to the second heat exchange module of the photon-plasma decomposition unit by the heat transfer pipe to be absorbed;
D. sending the oxidized catalyst for hydrogen production produced in the second water splitting unit back to the photon-plasma decomposition unit by the feed pipe to be recycled between the photon-plasma decomposition unit and the second water splitting unit;
E. reducing the oxidized catalyst for hydrogen production into the catalyst for hydrogen production and generating oxygen gas at the same time by the photon-plasma decomposition unit, and then sending the oxygen gas generated to the hydrogen power generation unit by the feed pipe to work with the hydrogen gas from the second water splitting unit to the hydrogen power generation unit by the feed pipe for producing green power and water; and
F. sending the water produced in the hydrogen power generation unit to the second water splitting unit by the water pipe.

9. The method as claimed in claim 8, wherein the photon-plasma decomposition unit includes a main body and a second heat exchange module arranged outside the main body while an artificial lightning module, a photon-plasma decomposition module, an energy retention, reformate, and conditioning module, and a separation and purification module are mounted in the main body in turn; after entering the photon-plasma decomposition unit, the oxidized catalyst for hydrogen production is treated by artificial lightning, photon plasma decomposition, energy retention, reformate, and conditioning, and separation and purification in turn to be reduced into the catalyst for hydrogen production.

10. The method as claimed in claim 9, wherein the oxidized catalyst for hydrogen production is selected from the group consisting of a common metal, metal alloy, metal oxide, and a combination thereof.

11. A method of implementing the green hydrogen and green power production system as claimed in claim 4 comprising the steps of:
A. delivering the externally connected catalyst for hydrogen production to the raw material mixing unit by the feed pipe;
B. sending water from the external water source to the raw material mixing unit by the water pipe so that the catalyst for hydrogen production and the water are mixed in the raw material mixing unit;
C. delivering a mixture of the catalyst for hydrogen production and the water to the first water splitting unit to carry out water splitting therein for producing hydrogen gas and oxidized catalyst for hydrogen production and releasing both a larger amount of heat of enthalpy generated during production of the oxidized catalyst for hydrogen production and a small part of the catalyst for hydrogen production not completely reacted;
D. absorbing the heat of enthalpy by the first heat exchange module of the first water splitting unit and delivering the heat of enthalpy to the heat recovery unit by the heat transfer pipe; also delivering the catalyst for hydrogen production not completely reacted in the first water splitting unit to the heat recovery unit by the feed pipe;
E. delivering water from the external water source to the heat recovery unit by the water pipe so that the heat of enthalpy and the water gathered allow the catalyst for hydrogen production not completely reacted to be excited and reacted completely to generate hydrogen gas and oxidized catalyst for hydrogen production;
F. delivering the hydrogen gas and the oxidized catalyst for hydrogen production generated by the first water splitting unit and the heat recovery unit to the separation unit through the feed pipes for separating the hydrogen gas and the oxidized catalyst for hydrogen production in solid form;
G. sending the oxidized catalyst for hydrogen production separated from the separation unit to the photon-plasma decomposition unit by the feed pipe for reactivation and reduction to catalyst for hydrogen production;
H. delivering the catalyst for hydrogen production obtained to the second water splitting unit by the feed pipe for performing water splitting reaction, generating hydrogen gas and oxidized catalyst for hydrogen production, and releasing a large amount of heat of enthalpy generated during production of the oxidized catalyst for hydrogen production;
I. transferring the heat of enthalpy to the second heat exchange module of the photon-plasma decomposition unit by the heat transfer pipe to be absorbed;
J. delivering the oxidized catalyst for hydrogen production generated in the second water splitting unit to the heat recovery unit by the feed pipe to be recycled among the heat recovery unit, the separation unit, the photon-plasma decomposition unit, and the second water splitting unit in turn;
K. generating oxygen gas in the photon-plasma decomposition while the oxidized catalyst for hydrogen production is reduced to the catalyst for hydrogen production in the photon-plasma decomposition unit and sending the oxygen gas to the hydrogen power generation unit by the feed pipe to react with the hydrogen gas generated in and coming from the first water splitting unit and the second water splitting unit to the hydrogen power generation unit through the feed pipes and produce green power and water; and
L. sending the water produced from the hydrogen power generation unit to the second water splitting unit by the water pipe.

12. The method as claimed in claim 11, wherein the photon-plasma decomposition unit includes a main body and a second heat exchange module arranged outside the main body while an artificial lightning module, a photon-plasma decomposition module, an energy retention, reformate, and conditioning module, and a separation and purification module are mounted in the main body in turn; after entering the photon-plasma decomposition unit, the oxidized catalyst for hydrogen production is treated by artificial lightning, photon plasma decomposition, energy retention, reformate, and conditioning, and separation and purification in turn to be reduced into the catalyst for hydrogen production.

13. The method as claimed in claim 12, wherein the catalyst for hydrogen production is selected from the group consisting of a common metal, metal alloy, metal oxide, and a combination thereof.
